(19) United States
(12) Patent Application Publication
(10) Pub. No.: US 2014/0023820 A1
(43) Pub. Date: Jan. 23, 2014

(54) COMPOSITE MATERIAL BASED ON A NATURAL-FIBER-REINFORCED PLASTIC

(71) Applicants: Sebastian Muhlbauer, Leipzig (DE); Volker Von Drach, Munchen (DE)

(72) Inventors: Sebastian Muhlbauer, Leipzig (DE); Volker Von Drach, Munchen (DE)

(73) Assignee: ECCO GLEITTECHNIK GMBH, Seeshaupt (DE)

(21) Appl. No.: 13/983,269

(22) PCT Filed: Feb. 6, 2012
(86) PCT No.: PCT/EP2012/051975

§ 371 Date: Oct. 9, 2013

(30) Foreign Application Priority Data
Feb. 4, 2011 (DE) 10 2011 010 371.6

(51) Int. Cl. B32B 5/12; B32B 5/26; D06N 3/00

(52) U.S. Cl. CPC B32B 5/12; D06N 3/0011; B32B 5/26
USPC 428/113; 442/153; 442/394; 442/413

(57) ABSTRACT

The invention relates to a composite material based on a natural-fiber-reinforced plastic, which comprises at least one layer of a spunlace non-woven fabric made of natural fibers as the reinforcing material. The composite material can be used in particular to produce sporting equipment, such as skateboards.

The present invention relates to a composite material based on a natural-fiber-reinforced plastic with a reinforcement material made of a spunlace nonwoven made of natural fibers.

Natural-fiber-reinforced plastics are known. They are frequently based on epoxy systems, and comprise natural fibers as reinforcement materials: see by way of example WO 00/06632. However, their strength properties and elasticity properties are not yet satisfactory.

It was therefore an object of the present invention to provide composite materials based on a natural-fiber-reinforced plastic with improved strength properties and improved elasticity properties.

Surprisingly, it has been found that said object is achieved when a spunlace nonwoven made of natural fibers is used as reinforcement material.

The present invention therefore provides a composite material based on a matrix made of a preferably thermoset plastic which comprises, as reinforcement material, at least one ply of a spunlace nonwoven made of natural fibers.

Spunlace nonwovens and production thereof are known: see by way of example Ullmann's Encyclopedia of Industrial Chemistry, 5th edn., vol. A17, page 578 or http://web.utk.edu/-mse/Textiles/Spunlace.htm.

Spunlace nonwovens made of natural fibers are obtainable commercially or can be produced conventionally. Natural fibers that can be used are flax fibers, hemp fibers, sisal fibers, jute fibers, kenaf fibers, cotton fibers, coconut fibers, nettle fibers, ramie fibers, bamboo fibers, or other vegetable fibers. It is preferable to use bast fibers such as flax fibers or hemp fibers.

Materials which have proven to be particularly suitable are the natural fibers that can be produced by the processes described in WO 90/12906 and WO 00/66819.

These are ultrasonicated vegetable fibers or else vegetable fibers where the individual fibers have been fibrillated. Preference is always given to flax fibers.

The nonwovens are advantageously produced from cleaned vegetable fibers and/or bleached vegetable fibers.

It is also possible to use mixtures of the natural fibers with synthetic fibers, such as glass fibers, carbon fibers, aramid fibers, etc. The amount of synthetic fibers can be from 5 to 95% by weight, preferably from 10 to 50% by weight.

The thickness of the spunlace nonwoven used, expressed as weight per unit area in g/m², depends on the intended application. The weight per unit area is generally in the range from 50 g/m² to 300 g/m², in particular from 70 g/m² to 250 g/m².

By virtue of the method of production of the spunlace nonwovens (water-jet bonding), the arrangement generally has the fibers of the nonwoven in two directions, generally perpendicularly superposed. The tensile strength of the spunlace nonwoven in the two directions is different. For the purposes of the present invention, the direction designated as preferential direction is that having the higher tensile strength. The tensile strength can be determined in a known manner, for example in accordance with ASTM D5035-95 (strip method) or ISO 13934-1.

It is preferable that the composite material takes the form of an elongate panel, where one of the axes (longitudinal axis) of the panel is longer than the other (transverse axis). In one embodiment, the arrangement of the spunlace nonwoven is such that the preferential direction of the fibers of the spunlace nonwoven forms an angle of at least 20°, in particular at least 30°, or 35°, for example from 30° to 75°, with the longitudinal axis of the panel.

The invention also provides a flat component which comprises at least one layer made of a plastics material or of a timber material, and which comprises at least one layer made of the composite material. The arrangement of the layer(s) made of the composite material can be as desired, for example on both sides of the plastics material or timber material, between two layers made of the plastics material or the timber material, etc. If the plastics material or timber material has two or more layers, these can be identical or different.

In one embodiment, the arrangement of the spunlace nonwoven in the flat component is such that the preferential direction of the fibers of the spunlace nonwoven forms an angle of at least 20° with the longitudinal axis of the flat component. Torsion of the flat component is thus reduced.

In another embodiment, the arrangement of the spunlace nonwoven in the flat component is such that the preferential direction of the fibers of the spunlace nonwoven is parallel to the longitudinal axis of the flat component. The stiffness of the flat component is thus increased.

In another embodiment, the flat component is composed of a core made of the plastics material or the timber material, where two layers of the composite material have been applied to the core and can be on one side or on each of the two sides of the core. The manner of application of one of the layers of the composite material here is such that the preferential direction of the fibers of the spunlace nonwoven is parallel to the longitudinal axis of the flat component and the preferential direction of the fibers of the other spunlace nonwoven forms an angle of at least 20° with the longitudinal axis of the flat component. The core can be composed of one or more layers of the plastics material or timber material, and these can be identical or different.

The spunlace nonwoven can cover the entire area of the flat component or only a portion thereof. It can be advantageous to apply the spunlace nonwoven in the form of strips, known as stringers. If necessary by virtue of the application sector or the intended application, the strips can have different length and/or different width. If the strips are by way of example used in skateboards, the length of the strips that form an angle with the longitudinal axis of the flat component is generally in the range from 20 to 60 cm, their width being in the range from 3 to 15 cm. In one particularly suitable embodiment, the arrangement has the strips that form an angle with the longitudinal axis of the flat component at an angle to one another, i.e. forming an X.

The flat component of the invention is generally produced by laminating the individual components (reinforcement fibers, composite material, or spunlace nonwoven, and wood veneers) in layers on top of one another, and using an adhesive and/or the matrix material for the reinforcement fibers and/or the spunlace nonwoven for fixing. Curing can be achieved at room temperature or at elevated temperature in a conventional manner, for example in vacuo or under superatmospheric pressure, in order to achieve maximum fiber volume content.

Particular plastics that can be used for the matrix material of the composite material are thermosets. Thermosets are known to be produced from oligomers via irreversible and dense crosslinking, optionally with addition of other monomers or polymers. The term thermosets here means not only the raw materials prior to crosslinking (the resins that have not yet been cured) but also the hardened reaction products. Examples of suitable thermosets are melamine resins, phenolic resins, epoxy resins, and silicone resins. Epoxy resins are preferred. Epoxy resins based on natural oils have proven to be particularly suitable. Natural oils are mixtures of different fatty acid glycerides having a proportion of unsaturated fatty acid moieties. Examples of oils of this type are rapeseed oil, sunflower oil, soy oil, linseed oil, hemp oil, castor oil, coconut oil, and palm oil. Said oils can be epoxidized in a known manner and can then be used to produce the composite materials. Preference is given to epoxy resins based on linseed oil.

The matrix material made of the thermosets used in the invention can be modified via addition of thermoplastic polymers, for example polyolefins, such as polyethylene or polypropylene, or polyesters, such as polyethylene terephthalate.

It is moreover possible to add conventional auxiliaries to the composite materials, examples being flame retardants, color pigments, UV absorbers, and also organic and/or inorganic fillers. The amounts usually used of the auxiliaries are in the range of about 0.1 to 5% by weight.

The composite materials can be processed to give moldings by using known production technologies, for example the autoclave, winding, manual lamination, or resin injection technique. The spunlace nonwoven here is usually introduced into an uncured matrix composition of the plastic or saturated therewith, i.e. wetted and encapsulated. The resultant moldings are then cured in a usual manner, for example via addition of hardeners and/or via heating.

The abovementioned thermosets and thermoplastics can be used as plastics material for the flat component.

The composite materials of the invention can by way of example be used as flat components for the following sectors:
sports equipment, for example skateboards inclusive of Iongboards, surfboards, windsurfing boards, skis, snowboards, tennis racquets, badminton racquets, or table-tennis racquets;
vehicle construction, for example in the form of bumpers, spoilers, vehicle cladding, or for trailers or motor homes, or internal equipment for vehicles, etc.;
aircraft construction and railroad construction, for example as shell element or cladding for cabin construction, for gliders, etc.;
construction industry, for example in façade construction, bridge construction, concrete construction (shuttering), pipeline construction, window construction, warehouse construction, racking-system construction, bathtubs, shower troughs, washbasins, etc.;
furniture industry, for example for drawer systems, stackable crates, cladding, etc.;
toy industry, for example for model construction, toys, etc.;
packaging and transport industry, for example for containers, such as canisters, drums, tanks, cases, transport containers, ski boxes, hinged-base containers, drawer systems, stackable crates, etc.;
safety engineering, for example for the production of protective helmets, in flood protection or noise protection, for barrier systems, signs, etc.;
mechanical engineering and construction of apparatus, for example for rotor blades of wind turbines or windmills.

The composite materials of the invention feature high strength and resilience, and are environmentally compatible not only during production but also during disposal.

The present invention also provides a flat component in the form of a skateboard panel which comprises a core made of at least one timber-based layer, and optionally comprises at least one fiber-reinforced layer, and optionally comprises at least one further layer made of a composite material of the invention. It is advantageous to use a core made of a laminate made of a plurality of timber-based layers.

In one embodiment, the arrangement has at least one fiber-reinforced layer on at least one side of the core. It is preferable to arrange two fiber-reinforced layers on the two sides of the core. The second layer advantageously extends only over the middle region of the panel.

In another embodiment, the structure of the panel can be supplemented by the stringers mentioned, or the second layer mentioned in the middle region of the skateboard panel is replaced by stringers. This can have a controlled effect on flexibility behavior and/or running performance.

In another embodiment, the arrangement has the layer made of the composite material on one or on both fiber-reinforced layer(s). The layer made of the composite material therefore generally forms the external layer (apart from any possible decorative layers).

The fiber-reinforced layer generally likewise involves a composite material made of a thermoset matrix which comprises fibers, in particular glass fibers or carbon fibers.

The structure of the skateboard panel, with the exception of the two outer layers, uses the composite materials of the invention in a conventional manner. The usage sector here determines the design of the structure. The skateboard panel is produced conventionally, for example as described above for the production of the flat component.

It has proven particularly advantageous to provide two mutually superposed layers made of the composite material with the spunlace nonwoven and to arrange these in such a way that the preferential direction of the fibers of one of the nonwovens forms an angle a of at least 20° with the longitudinal axis of the panel. The arrangement of the nonwoven here can be such as to produce the angle in the direction of running or in a direction opposite to the direction of running. The first layer can optionally be replaced by, or supplemented by, stringers. It is particularly advantageous to arrange the second layer made of the composite material in such a way that the preferential direction of the fibers of the spunlace nonwoven an opposite angle -a with the longitudinal axis of the skateboard or preferably no angle therewith, the preferential direction of the fibers therefore running parallel to the longitudinal axis. The angle −α is advantageously likewise at least 20°. Both angles are generally in the range from 30 to 75°. The second layer, too, can optionally be replaced by, or supplemented by, stringers.

The arrangement of the second fiber-reinforced layer, extending over the middle region of the panel, is advantageously likewise such that the preferential direction of the fibers of the layer forms an angle al of at least 20° with the longitudinal axis of the panel. The arrangement of the nonwoven here can be such that the angle is produced in the direction of running or in a direction opposite to the direction of running. The angle al is advantageously smaller than the angle a. It is generally in the range from 20 to 70°. The arrangement of the first fiber-reinforced layer is generally such that the preferential direction of the fibers runs parallel to the longitudinal axis, i.e. the layer forms no angle with the longitudinal axis.

The composite materials and the fiber-reinforced layers applied in such a way that the preferential direction of the fibers runs parallel to the longitudinal axis of the board absorb tensile and flexural stresses. The layers in which the preferential direction of the fibers forms an angle with the longitudinal axis absorb torsional and transverse contraction stresses. The fiber-reinforced layers applied in the central region reinforce the board at the location of the highest load, namely in the middle between the axes of the running wheels of the finished board. The skateboard panel of the invention therefore has high stress and resilience, which are also maintained over a prolonged period.

The example below illustrates the invention.

### Production and Structure of a Longboard

The core is formed from a central wood veneer of thickness 1.4 mm, both sides of which are veneered with in each case a wood veneer (thickness 2.4 mm), with the aid of an adhesive (length of veneers 1050 mm, width 250 mm). A fiber-reinforced layer made of carbon fibers (woven-fiber fabric, 300 g/m²) is applied to the laminate on both sides over the entire area, and the carbon fibers here are impregnated with HP-E55 L epoxy resin (HP Textiles) or with an epoxy resin based on a natural oil (from 400 to 600 g/m² of the resin system Dracowol EP-10/1 and Dracowol HOL-2 from Dracosa AG) in a mixing ratio of 2:1. The preferential direction of the carbon fibers is parallel to the longitudinal axis of the laminate. A second fiber-reinforced layer of identical structure is applied thereto in such a way that the preferential direction of the fibers runs at an angle of about 30° to the longitudinal axis of the panel. However, the second layer extends only within the middle region of the laminate. A composite material made of a spunlace nonwoven (from 150 to 200 g/m²) impregnated with HP-E55 L epoxy resin or with an epoxy resin based on a natural oil (from 400 to 600 g/m² of the resin system Dracowol EP-10/1 and Dracowol HOL-2 from Dracosa AG in a mixing ratio of 2:1) is thereto. The preferential direction of the flax fibers forms an angle of 45° with the longitudinal axis of the panel. A second layer made of the composite material is applied thereto, and has the same structure and composition as the first layer, but the preferential direction of the flax fibers runs parallel to the longitudinal axis of the panel. On the other side of the timber-based laminate, the same layers are applied. The molding is then cured for a number of hours in a press, optionally at a temperature of from 50 to 70° C. After the molding has been allowed to stand for a number of days for post-curing, it is cut to size.

1-15. (canceled)

16. A composite material based on a natural-fiber-reinforced thermoset plastic which comprises, as reinforcement material, at least one ply of a spunlace nonwoven made of natural fibers.

17. The composite material as claimed in claim 16 in the form of an elongate panel, where the preferential direction of the fibers of the spunlace nonwoven forms an angle of at least 20° with the longitudinal axis of the panel.

18. The composite material as claimed in claim 16, where the spunlace nonwoven comprises flax fibers, hemp fibers, sisal fibers, jute fibers, kenaf fibers, cotton fibers, coconut fibers, nettle fibers, ramie fibers, bamboo fibers, or bast fibers of other plants, or a mixture of two or more of said fibers.

19. The composite material as claimed in claim 18, where the spunlace nonwoven comprises ultrasonicated or fibrillated fibers.

20. The composite material as claimed in claim 16, where the spunlace nonwoven comprises flax fibers.

21. The composite material as claimed in claim 16, where the spunlace nonwoven comprises ultrasonicated or fibrillated flax fibers.

22. The composite material as claimed in claim 16, where the spunlace nonwoven comprises a mixture of natural fibers and synthetic fibers.

23. A flat component which comprises at least one layer made of a plastics material or of a timber material, and which comprises at least one layer made of the composite material as claimed in claim 16.

24. A skateboard panel which comprises a core made of at least one layer made of a timber material, and which optionally comprises at least one fiber-reinforced plastics layer, and which comprises at least one further layer made of a composite material as claimed in claim 16, where the arrangement of the spunlace nonwoven is such that the preferential direction of the fibers of the spunlace nonwoven forms an angle of at least 20° with the longitudinal axis of the panel.

25. The skateboard panel as claimed in claim 24, where the arrangement has, on both sides of the core made of the timber material layer, at least one fiber-reinforced layer, where there is optionally a second fiber-reinforced layer which extends only over the central region of the panel.

26. The skateboard panel as claimed in claim 24, where the preferential direction of the fibers of the second fiber-reinforced layer forms an angle of at least 20° with the longitudinal axis of the panel.

27. The skateboard panel as claimed in claim 24, where the arrangement has at least one layer made of the composite material on the fiber-reinforced layer.

28. The skateboard panel as claimed in claim 24, where there are, arranged on the fiber-reinforced layer, at least two layers made of the composite material, and where one layer has been applied in such a way that the preferential direction of the fibers of the spunlace nonwoven forms an angle of at least 20° with the longitudinal axis of the panel, where the second layer made of the composite material has optionally been applied in such a way that the preferential direction of the fibers of the spunlace nonwoven is parallel to the longitudinal axis of the panel.

29. The skateboard panel as claimed in claim 28, where the first layer made of the composite material has been replaced by strips made of the composite material which have optionally been arranged at an angle to one another.

30. A skateboard comprising a skateboard panel as claimed in claim 24.
